(19) United States
(12) Patent Application Publication
(10) Pub. No.: US 2011/0269404 A1
(43) Pub. Date: Nov. 3, 2011

(54) ACTIVE ANTENNA DEVICE, NETWORK DEVICE AND ACCESS POINT OF A WIRELESS NETWORK

(75) Inventors: Zhen Ping Hu, Beijing (CN); Andreas Kister, Loerrach (DE); Mattias Lampe, Wolfenbuettel (DE); Matthias Seifert, Braunschweig (DE); Ji Feng Tian, Beijing (CN)

(73) Assignee: SIEMENS AKTIENGESELLSCHAFT, MUENCHEN (DE)

(21) Appl. No.: 13/142,325

(22) PCT Filed: Dec. 25, 2008
(86) PCT No.: PCT/CN2008/002080

§ 371 Date: Jun. 27, 2011

(51) Int. Cl. H04B 1/04; H04W 4/00

(52) U.S. Cl. 455/67.11; 455/127.2; 455/115.1

(57) ABSTRACT

An active antenna device, a network device, an access point equipped with the network device and a plurality of distributed active antenna devices form components of a communication system. The active antenna device contains an antenna unit, an amplifier unit and a control unit, wherein the amplification of the amplifier unit is controlled by the control unit according to an instruction from a management unit located in the network device. The devices achieve a low handover frequency whereas rendering the communication less vulnerable to contentions and/or interference than in the conventional systems.

### TECHNICAL FIELD

The invention relates to an active antenna device, a network device and an access point of a wireless network, especially of a vehicle to roadside communication network.

### BACKGROUND TECHNOLOGY

In vehicle to roadside data communication such as wireless CBTC (Communication Based Train Control) or PIS (Passenger Information Systems), for example, the mobility of a client and the resulting rapid change of channel conditions make reliable and efficient communication difficult. Although careful planning of AP (Access Point) placement, antenna configuration and hardware setup can take into account the effects of propagation path loss, shadowing and (to some extent) multi-path propagation, other effects such as interference from other systems or temporary changes in propagation conditions are less predictable and can severely affect system performance, i.e. data throughput and link reliability.

In a conventional wireless network, each AP is equipped with a single antenna unit. In this application the term “antenna unit” can refer to a single antenna or to a set of antennas used in a diversity scheme. It also covers antenna arrays used in MIMO (Multiple Input Multiple Output) communication systems (such as IEEE 802.11n wireless network) or in beam-forming schemes. In each of these cases, however, all antenna elements forming the antenna unit of an AP are located close to each other, i.e. their distance is small compared to the distance between APs.

FIG. 1 depicts a typical setup of a vehicle to roadside (here train to trackside) communication network employing antenna diversity at AP and client sides. For choosing a suitable distance between adjacent APs, various aspects must be taken into account:
Radio propagation: Given the transmission power, receiver sensitivities and antenna gains of AP and client, the distance between APs must be small enough to guarantee that the received signal strength at any point of the client's motion path is sufficient to allow communication with at least one AP. In practice some overlap of the coverage ranges of adjacent APs is required in order to allow a smooth handover.
Cost: Smaller distance between APs results in larger number of APs and thus higher equipment costs.
Handover frequency: Frequent handoffs will increase overhead and reduce the throughput. Therefore the distance between adjacent APs should not be chosen too small. Vehicle speed plays an important role in this context since a fast moving vehicle will pass from one AP to the next in a shorter interval than a slow vehicle. Consequently high speed vehicles demand for a larger AP spacing in order to keep the handover-induced overhead within acceptable limits.
Frequency re-use: Since the RF (Radio Frequency) bandwidth is limited, dense AP deployment will lead to contention and/or interference between APs using the same RF. This affects the efficiency of bandwidth utilization.

### SUMMARY OF THE INVENTION

Therefore this invention aims at providing a more predictable and reliable radio link between an AP and a wireless terminal in a wireless network and allowing a relatively large spacing between APs thus achieving a low handover frequency whereas rendering the communication less vulnerable to contentions and/or interference than in the conventional systems.

The object of the invention is achieved by an active antenna device. The active antenna device comprises an amplifier unit for amplifying a RF signal and an antenna unit for converting the RF signal to an electromagnetic wave and vice versa. The active antenna device further comprises a control unit for receiving an instruction from a management unit and generating a control signal according to the instruction, such that the amplification of the amplifier unit is controlled by the control signal.

The object of the invention is further achieved by a network device for connecting a wireless terminal to a wireless network. The network device has a management unit for controlling at least an active antenna device according to the invention, wherein the amplification of the amplifier unit is controlled according to the instruction from the management unit.

The object of the invention is further achieved by an AP. The AP has a network device and a plurality of distributed active antenna devices according to the invention and additionally a power distribution unit for coupling the network device and the active antenna devices, wherein the amplification of the amplifier unit of each active antenna device is controlled according to the instruction from the management unit of the network device.

In an embodiment of the invention, the network device and the active antenna devices of the AP are coupled to each other by a wire link provided by the power distribution unit. In this case, the instruction of the management unit can be transmitted to the control unit via the wire link together with traffic data signal between the network device and the wireless terminal on the RF of the traffic data signal, or on a separate RF, or as a low frequency or baseband signal.

The management unit is implemented to derive the instruction for the control unit of each active antenna by calculating the RF signal loss between the network device and the respective active antenna device.

More advantageously, each active antenna device can further comprises a receiver unit for receiving the RF signal output from the antenna unit and a measurement unit for measuring a received signal output from the receiver unit. Depending on the complexity of the receiver unit, propagation losses between the respective active antenna device and the wireless terminal even interferences suffered by the respective active antenna device can be measured by the measurement unit. Furthermore, the measurement unit can be provided for transmitting its measurement result to the management unit via the wire link. In this case, the management unit can be further implemented to update the instruction dynamically on the basis of the measurement result such that the propagation losses even the interferences can be counteracted by dynamic adjustment of the amplification of the amplifier unit.

Besides the measurement result mentioned above, an estimation of the wireless terminal's position and/or motion or in combination of the measurement result can be used by the management unit to update the instruction. This estimation can be made based on the measurement results gathered from the active antenna devices and/or information obtained from other sources. This way, the amplification of the amplifier unit can be controlled such that only the active antenna device near the wireless terminal is activated while those further away are deactivated. The radiated power of the AP is therefore spent where it is really needed.

In an advantageous embodiment of the invention, the power distribution unit is provided with two wire links, such that the traffic data signal and the instruction can be transmitted separately with the traffic data signal on one wire link and the instruction on a second wire link. In this case, exchange of relatively large amounts of data on the second wire link is made possible.

In another embodiment of the invention, a wireless link can be further provided between the network device and the active antenna devices, via which wireless link the instruction can be transmitted from the management unit to the control unit.

Therefore, the receiver unit of each active antenna device is further provided for the control unit to receive the instruction via the wireless link.

Additionally, each active antenna device can further comprise a transmitter unit for the measurement unit to transmit its measurement result to the management unit via the wireless link.

The transmitter unit and the receiver unit of the active antenna device can be further provided for communicating with a cellular network infrastructure. In this case, the active antenna device becomes a cellular network node, which can enable the communication between the active antenna devices of the same AP, of different APs and between the active antenna device and any other suitable devices independent of the AP. This autonomous communication can be exploited, for example, to obtain information about the propagation losses, to coordinate handover between different APs or for diagnostic purposes in case of a defective power distribution unit.

The invention is particularly advantageous when embodied in a vehicle to roadside communication network, while the active antenna devices are in this case distributed along the motion path of the client.

### BRIEF DESCRIPTION OF THE DRAWINGS

The invention is described and explained in more detail below with reference to the exemplary embodiments shown in the figures.

FIG. 1 shows a typical setup of a conventional train to trackside communication network,

FIG. 2 shows an exemplary setup of a train to trackside communication network according to the invention,

FIG. 3 shows a schematic of the network device and the active antenna device in an exemplary embodiment of the invention,

FIG. 4 shows a schematic of the network device and the active antenna device in an advantageous embodiment of the invention,

FIG. 5 shows an alternative schematic of the active antenna device in the embodiment of FIG. 4,

FIG. 6 shows a schematic of the network device and the active antenna device in another embodiment of the invention.

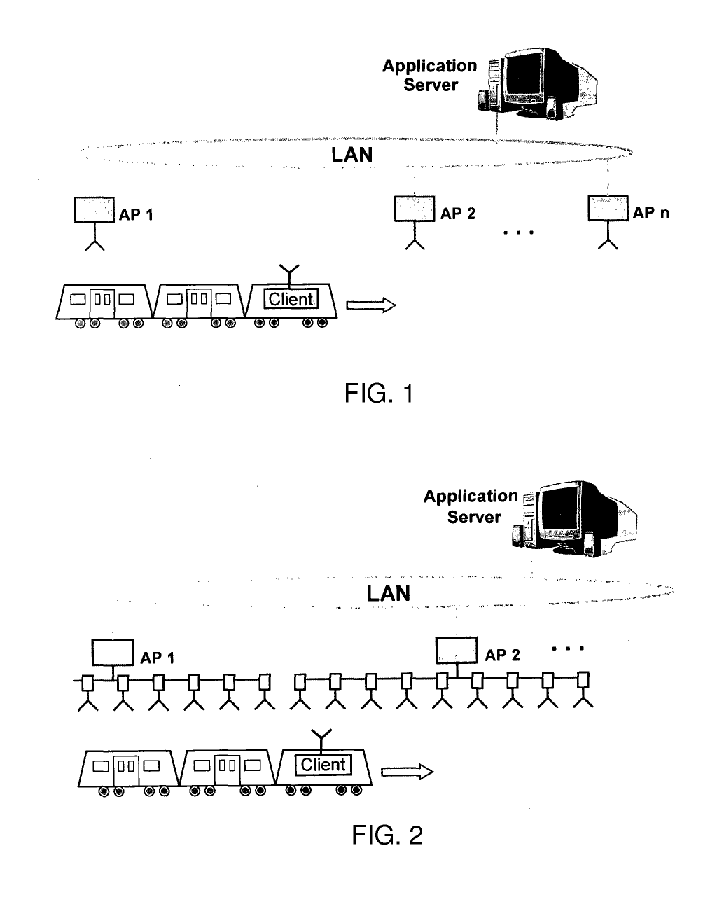

### DETAILED DESCRIPTION OF THE EMBODIMENTS

An exemplary setup of a train to trackside communication network according to the invention is given in FIG. 2. In this setup, each AP is equipped with a number of active antenna devices that are distributed along the rail, i.e. the motion path of the client. The network device and the distributed active antenna devices of an AP are coupled to each other by a wire link provided by the power distribution unit of the AP. For example, the RF port of the network device is connected to a low-loss RF transmission line (preferably coaxial cable) to which the individual active antenna devices are coupled by asymmetric power splitters or comparable coupling means. Because the RF signal loss between the network device and the active antenna devices will be different for each active antenna device due to the different cable lengths, different coupler losses and different amounts of power coupled out by the other active antenna devices, the amplification of the amplifier unit of each active antenna device will be controlled by the management unit of the network device to compensate these differences.

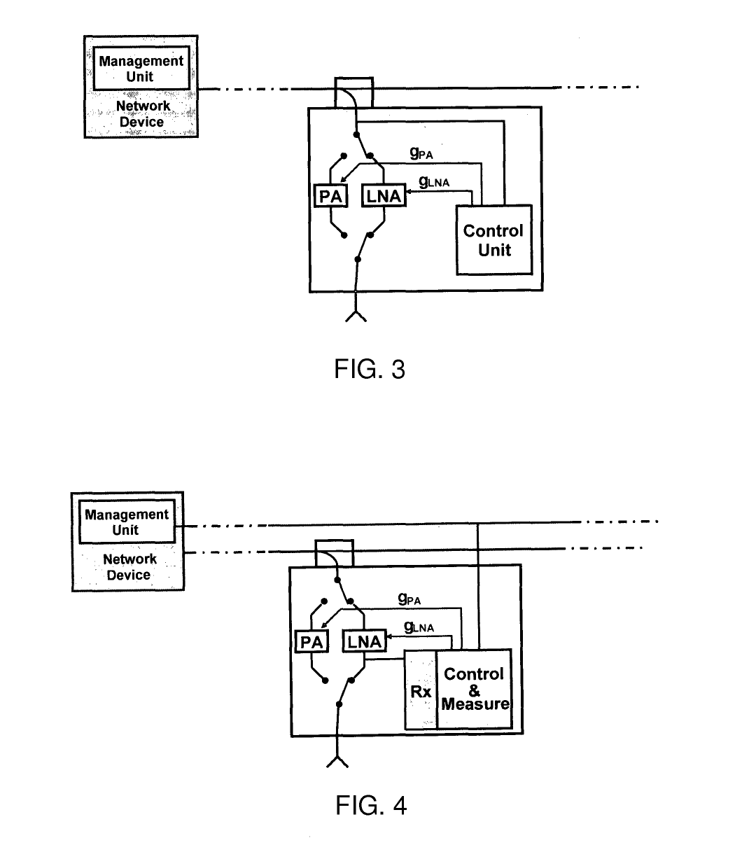

FIG. 3 shows a schematic of the network device and the active antenna device in an exemplary embodiment of the invention. At the active antenna device side, the amplifier unit comprises a controllable PA (power amplifier) for amplifying the RF signal input to the antenna unit and/or a controllable LNA (low noise amplifier) for amplifying the RF signal output from the antenna unit. The control unit receives the instruction from the management unti via a wire link and generates the control signal to control the gain factors of the controllable PA and/or the controllable LNA. At the network device side, the management unit is implemented to derive the instruction for the control unit of each active antenna by the offline computation of the RF signal loss between the network device and the respective active antenna device.

In the most basic mode of operation, the gain factors of the controllable PA and/or the controllable LNA will be statically set at system startup and remain unchanged during further operation. The gain factors can be configured by the instruction such that the differences of the RF signal loss for the individual active antenna devices are compensated rendering a uniform radiated power of each active antenna device and a uniform received signal strength of the network device from each active antenna device.

Instead of equalizing the radiated power and the received signal strength, it is also possible to deliberately create a non-uniform radiated power and received signal strength among the active antenna devices, for example, to compensate known differences in propagation conditions.

For the described static configuration of the gain factors, in principle it would also be possible to set the gain factors locally at each active antenna device, however, the central control of the management unit is of advantage to simplify system set-up and maintenance.

The instruction of the management unit is transmitted to the control unit via the wire link together with traffic data signal between the network device and the wireless terminal. The instruction can be transmitted on the RF of the traffic data signal or on a separate RF, using standard or proprietary protocols. Alternatively, the instruction can be transmitted via the wire link as a baseband signal or being modulated on a low frequency. Insertion of the low frequency or baseband signal into the wire link can be achieved by relatively simple means (cf. bias-tees).

FIG. 4 is a schematic of the network device and the active antenna device in an advantageous embodiment of the invention. In this embodiment, the power distribution unit, which couples the network device and the active antenna device, is provided with two wire links, such that the traffic data signal and the instruction can be transmitted separately with the traffic data signal on one wire link and the instruction on a second wire link. For example, the power distribution unit is provided with a coaxial cable for the traffic data signal and an Ethernet cable for the instruction. In this case, exchange of relatively large amounts of data on the second wire link is made possible.

In FIG. 4, the active antenna device further comprises a receiver unit for receiving the RF signal output from the antenna unit and a measurement unit for measuring a received signal output from the receiver unit. Depending on the complexity of the receiver unit, propagation losses between the active antenna device and the wireless terminal even interferences suffered by the active antenna device can be measured by the measurement unit.

Furthermore, the measurement unit is provided for transmitting its measurement result to the management unit via the second wire link. During implementation, the control unit and the measurement unit can be implemented as two modules or as an integrated signal process module as shown in FIG. 4. This signal process module thus can communicate with the management unit via the second wire link, for example, using Ethernet protocol.

Based on the measurement result, the management unit is further implemented to update the instruction dynamically such that the propagation losses even the interferences can be counteracted by dynamic adjustment of the amplification of the amplifier unit.

Although in principle, some de-centralized algorithms allowing each active antenna device to determine its own gain factors independently from the others might be thought of, it will in most practical cases be required or advisable to have the central management unit determine the gain factors and communicate them to the active antenna devices. The management unit will not only optimize the gain factors with respect to system performance but also make sure that the radiated power of all the active antenna devices does not exceed regulatory limits.

Besides the measurement result mentioned above, an estimation of the wireless terminal's position and/or motion (such as path, speed, moving direction, etc) or in combination of the measurement result can be used by the management unit to update the instruction. This estimation can be made by the management unit based on the measurement results gathered from the active antenna devices and/or information obtained from other sources, such as sensors, GPS modules, central servers, etc. This way, the amplification of the amplifier unit can be dynamically adjusted such that only the active antenna device near the wireless terminal is activated while those further away are deactivated. The radiated power of the AP is therefore spent where it is really needed.

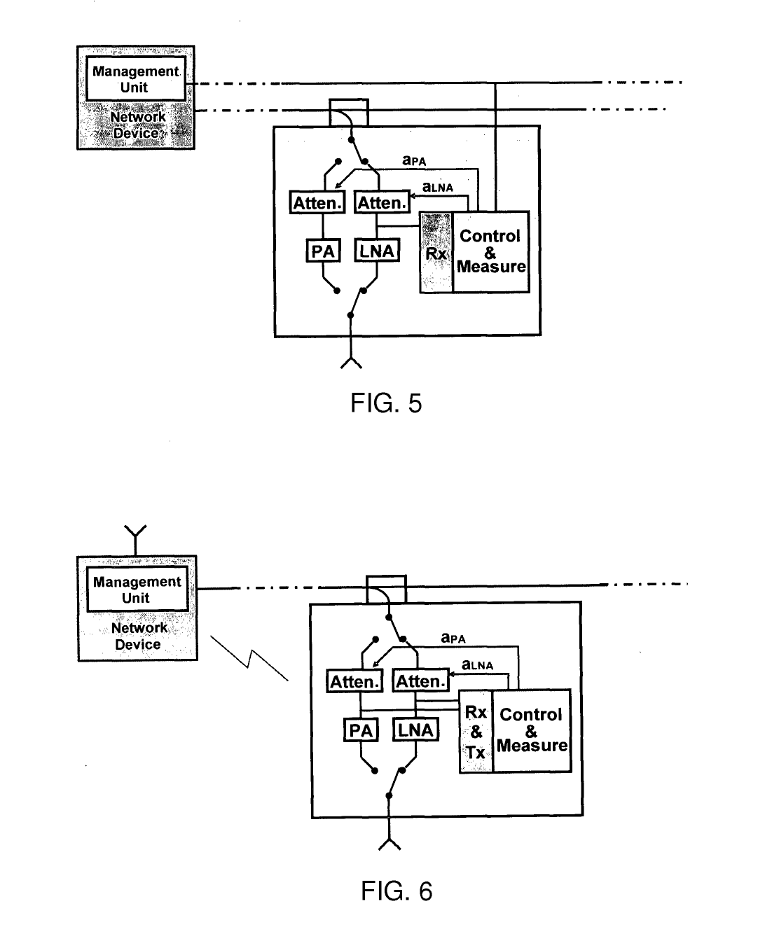

FIG. 5 shows an alternative schematic of the active antenna device in the embodiment of FIG. 4. Herein the amplifier unit comprises a controllable attenuator and a fixed gain PA coupled in series for amplifying the RF signal input to the antenna unit as well as a fixed gain LNA and another controllable attenuator coupled in series for amplifying the RF signal output from the antenna unit, and the receiver unit is arranged for receiving the RF signal output from the antenna unit after it is amplified by the fixed gain LNA. An important advantage of this structure is the fact that the output RF signal from the antenna unit is first amplified and then split into two paths, one to the network device and one to the receiver unit. Performing the split before the LNA would significantly reduce the SNR (Signal to Noise Ratio) at the network device. On the other hand, splitting the RF signal after the attenuator would prevent the receiver unit from receiving the signal in case a very large attenuation has been chosen by the management unit, for example, to deactive the active antenna device.

Practical design considerations, for example, availability of suitable hardware components, may let either the structure of the active antenna device in FIG. 4 or in FIG. 5 appear favourable.

If only low rate data communication between the active antenna device and the network device is required, the wireless approach can be a reasonable option. In another embodiment of the invention as shown in FIG. 6, a wireless link is further provided between the network device and the active antenna device, via which wireless link the instruction is transmitted from the management unit to the control unit. The receiver unit is therefore further provided for the control unit to receive the instruction via the wireless link. Additionally, the active antenna device further comprises a transmitter unit for the measurement unit to transmit its measurement result to the management unit via the wireless link.

The transmitter unit and the receiver unit of the active antenna device can be further provided for communicating with a cellular network infrastructure. In this case, the active antenna device becomes a cellular network node, which can enable the communication between the active antenna devices of the same AP, of different APs and between the active antenna device and any other suitable devices independent of the AP. This autonomous communication can be exploited, for example, to obtain information about the propagation losses, to coordinate handover between different APs or for diagnostic purposes in case of defective cables.

From the application perspective, the invention bears some resemblance with the concept of a leaky feeder system, for example, leaky coaxial cable or leaky waveguide. While a leaky feeder system can achieve a relatively uniform distribution of radiated power along a given motion path, the coupling loss, i.e. the ratio of transmission power fed into the cable to the power picked up by the wireless terminal (or vice versa) is high and increases with the distance from the cable. Leaky feeder systems are therefore advantageous only if a very small distance between feeder cable and wireless terminal can be guaranteed.

A system feeding a number of passive antennas rather than active ones from a common RF path will lead to different cable losses encountered by different antennas and thus to a non-uniform radiated power along the a given motion path. Although this difference in RF signal loss could be statically compensated by customizing the power splitter of each individual antenna to a different splitting ratio, active antennas can provide a more effective compensation of RF signal losses. Furthermore the invention allows a flexible adaptation to changing requirements, propagation conditions or interference scenarios. The radiated power allowed by regulatory limits can be concentrated on those active antenna devices that have a good radio channel to the wireless terminal. Active antenna devices registering a high level of interference can be excluded from contributing to the reception.

Today's low hardware cost may even let it appear feasible to place APs very densely along the motion path, i.e. as with the AP spacing comparable to the spacing of the active antenna devices according to the invention. Rather than distributing the RF signal to the active antenna devices and the need to establish an additional data connection between each active antenna device and the network device, each of the densely spaced APs would have a data connection (e.g. Ethernet) to the fixed network. Cabling cost might even be cheaper in this case. The main disadvantage of this scheme compared to the invention is the high handoff frequency resulting from the small distance between APs. Furthermore, in the invention several active antenna devices can be actively transmitting the same signal at the same time. With the dense AP scheme, only one AP at a time can transmit to the wireless terminal. For acknowledged communication, the same holds true for the transmission from the wireless terminal to the AP. Effectively only one AP can acknowledge the receipt at a time. These limitations could be overcome only with considerable effort and custom protocol and hardware designs at the APs and possibly wireless terminals. For the invented approach, only the active antenna device and the management unit are (relatively simple) custom designs. Implementation complexity is thus reasonably low. Furthermore, although the aspect of co-channel interference between APs according the invention also requires careful consideration, the possible interference scenarios in case of the dense AP scheme can be quite complex and may severely affect system performance even if the APs operate at reduced output power levels.

As a very important advantage of the invention, it must be pointed out that the RF signal loss between the network device and the active antenna device can to a large extent be compensated by increasing the transmission power of the network device. Regulatory limits apply only to the power radiated by all the active antenna devices of an AP but not to the transmission power of the network device. It may therefore be expected that the maximum coverage range by a single AP according to the invention can be significantly larger than that by a conventional AP.

According to the invention, consider a communication based train control (CBTC) or passenger information system (PIS) based on WLAN technology (IEEE 802.11a/b/g) with a distance of 200 m between APs. The maximum distance of the client to the nearest AP will be 100 m corresponding to a free space path loss of approximately 80 dB. It is assumed that the active antenna devices are spaced 10 m apart (20 active antenna devices per AP) and that all the active antenna devices radiate the same power, i.e. the gain factors are set statically such that the different RF signal losses are compensated and that the radiated power of an AP equals that of the conventional system. The radiated power per active antenna device is therefore 13 dB below the radiated power of a conventional AP. At a distance of 10 m from an active antenna device (This is a pessimistic assumption implying rather large distance between the active antenna device and the motion path of the client. An optimistic assumption would be slightly more than 5 m, i.e. half the distance between active antenna devices), neglecting radiated power contributed from neighbouring active antenna devices, the free space pathloss is approximately 60 dB. Thus the total loss in received signal power from the active antenna device corresponds to a gain of 7 dB compared that from a conventional AP. The gain can be significantly higher if the amplification of the amplifier unit is adaptively updated. Furthermore, the above calculation assumes a free space path loss in which the path loss exponent is 2. For higher path loss exponent, the gain will be larger.

1-23. (canceled)

24. An active antenna device, comprising:
an amplifier unit for amplifying a radio frequency signal;
an antenna unit for converting the radio frequency signal to an electromagnetic wave and vice versa; and
a control unit for receiving an instruction from a management unit and generating a control signal according to the instruction, such that an amplification of said amplifier unit is controlled by the control signal.

25. The active antenna device according to claim 24, wherein said control unit is implemented to receive the instruction via a wire link.

26. The active antenna device according to claim 24, further comprising:
a receiver unit for receiving the radio frequency signal output from said antenna unit; and
a measurement unit for measuring a received signal output from said receiver unit.

27. The active antenna device according to claim 26, wherein said measurement unit transmits its measurement result to the management unit via a wire link.

28. The active antenna device according to claim 26, wherein said amplifier unit has a controllable power amplifier for amplifying the radio frequency signal input to said antenna unit and a controllable low noise amplifier for amplifying the radio frequency signal output from said antenna unit.

29. The active antenna device according to claim 26, wherein said amplifier unit includes:
a controllable attenuator and a fixed gain power amplifier coupled in series for amplifying the radio frequency signal input to said antenna unit; and
a fixed gain low noise amplifier and another controllable attenuator coupled in series for amplifying the radio frequency signal output from said antenna unit, and said receiver unit is disposed for receiving the radio frequency signal output from said antenna unit after it is amplified by said fixed gain low noise amplifier.

30. The active antenna device according to claim 26, wherein said receiver unit is further provided for said control unit to receive the instruction via a wireless link.

31. The active antenna device according to claim 26, further comprising a transmitter unit for said measurement unit to transmit its measurement result to the management unit via a wireless link.

32. The active antenna device according to claim 31, wherein said transmitter unit and said receiver unit communicate with a cellular network infrastructure.

33. The active antenna device according to claim 24, wherein said antenna unit has a single antenna element.

34. The active antenna device according to claim 24, wherein said antenna unit has a set of antenna elements.

35. A network device for connecting a wireless terminal to a wireless network, the network device comprising:
a management unit for controlling at least an active antenna device having an amplifier unit for amplifying a radio frequency signal, an antenna unit for converting the radio frequency signal to an electromagnetic wave and vice versa, and a control unit for receiving an instruction from said management unit and generating a control signal according to the instruction, such that an amplification of the amplifier unit is controlled by the control signal.

36. The network device according to claim 35, wherein said management unit is implemented to derive the instruction by calculating a radio frequency signal loss between the network device and the active antenna device.

37. The network device according to claim 36, wherein said management unit updates the instruction based on a measurement of propagation losses between the active antenna device and the wireless terminal.

38. The network device according to claim 37, wherein said management unit updates the instruction based on a measurement of interferences to the active antenna device.

39. The network device according to claim 36, wherein said management unit updates the instruction based on an estimation of the wireless terminal's position and/or motion.

40. An access point, comprising:
a network device for connecting a wireless terminal to a wireless network, said network device having a management unit outputting an instruction;
a plurality of active antenna devices, each of said active antenna devices having an amplifier unit for amplifying a radio frequency signal, an antenna unit for converting the radio frequency signal to an electromagnetic wave and vice versa, and a control unit for receiving the instruction from said management unit and generating a control signal according to the instruction, such that an amplification of said amplifier unit is controlled by the control signal; and
a power distribution unit for coupling said network device and said active antenna devices, wherein the amplification of said amplifier unit of each of said active antenna devices is controlled according to the instruction from said management unit of said network device.

41. The access point according to claim 40, wherein said power distribution unit has a single wire link, via which traffic data signal between said network device and the wireless terminal and the instruction are transmitted.

42. The access point according to claim 41, wherein the traffic data signal and the instruction are transmitted on a same radio frequency.

43. The access point according to claim 41, wherein the traffic data signal and the instruction are transmitted on two separate radio frequencies.

44. The access point according to claim 41, wherein the instruction is transmitted on a low frequency or baseband.

45. The access point according to claim 40, wherein said power distribution unit has two wire links, via which a traffic data signal between said network device and the wireless terminal and the instruction are transmitted separately.

46. The access point according to claim 40, further comprising a wireless link between said network device and said active antenna devices, via said wireless link the instruction is transmitted.

47. The access point according to claim 40, wherein the wireless network is a vehicle to roadside communication network, while said active antenna devices are distributed along a motion path of the wireless terminal.
